(19) United States
(12) Patent Application Publication
(10) Pub. No.: US 2009/0080178 A1
(43) Pub. Date: Mar. 26, 2009

(54) Kitchen Appliance

(75) Inventor: Gerd Wilsdorf, Olching (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeräte GmbH, Munchen (DE)

(21) Appl. No.: 12/085,643

(22) PCT Filed: Nov. 28, 2006
(86) PCT No.: PCT/EP2006/069001

§ 371 Date: May 27, 2008

(30) Foreign Application Priority Data
Dec. 16, 2005 (DE) 10 2005 060 359.9

(51) Int. Cl. F21V 33/00

(52) U.S. Cl. 362/92; 362/253

(57) ABSTRACT

A household appliance, particularly a kitchen appliance, comprising at least one functional element with a top face. Said household appliance is characterized in that the top face of the functional element is made at least in part of a translucent material while at least one illumination device which emits light at least in part in the direction of the top face of the functional element is provided below the top face in the household appliance. The invention creates a ceiling light and/or a room light in addition to the normal function of the household appliance.

The present invention relates to a household appliance, in particular a kitchen appliance such as e.g. an extractor hood which has a functional component comprising a top side.

Such a household appliance in the form of an extractor hood is described in DE 101 10 818 A1, for example. In this arrangement an illumination entity is provided in the hood shield casing of the vapor extractor hood. A light-guiding element whose light-emitting surfaces project into an external region of the hood shield casing is assigned to the illumination component of the illumination entity. By virtue of this extractor hood a light band which runs along the edge is created, wherein said light band possibly also radiates light partially in the direction of a hob located beneath the extractor hood. The disadvantage of this vapor extractor hood is that, as a result of the arrangement of the light-guiding element, the light intensity of the illumination component must be restricted in order to avoid dazzling the user of the vapor extractor hood. Consequently, the illumination entity can at best serve as a decorative element of the vapor extractor hood.

The object of the present invention is to create a household appliance by means of which a pleasant illumination of the environment of the household appliance can be achieved.

The object is achieved according to the invention by means of a household appliance, in particular a kitchen appliance, which has at least one functional component comprising a top side. The household appliance is characterized in that the top side of the functional component consists at least partially of a translucent material, and in that at least one illumination device is provided in the household appliance beneath the top side, said illumination device at least partially radiating light in the direction of the top side of the functional component.

As a result of the translucent design of the top side of the functional component, onto which light from the illumination device is at least partially radiated, the environment above the functional component can be illuminated. As a result of reflection on a room ceiling above the functional component, in particular a kitchen ceiling, indirect illumination can thus be generated.

As a result of integrating the illumination device in the household appliance, said illumination device can also be easily connected to the power supply of the household appliance. It is therefore possible, by means of a single power connection interface, to supply power not only for the household appliance function but also for illuminating the environment. A separate plug connection socket and a separate cable for the environmental illumination are not required. This is advantageous in kitchens in particular, since plug connection sockets and cables adversely affect the appearance of the kitchen and represent safety hazards, and must be specially protected against high temperatures and the ingress of liquids and foreign matter.

The illumination device can be provided in the household appliance in addition to a functional illumination of the functional component. Such a functional illumination can be a workplace illumination or the internal illumination of the functional component. The functional illumination is usually directed downward. By virtue of the illumination device being an additional device, it can be controlled separately from the functional illumination. Consequently, even if a functional illumination is switched off, it is possible to illuminate the environment above the functional component and effect an indirect illumination of the kitchen. In addition, the separate control also allows an adjustment of the functional illumination as required, without influencing the indirect illumination at the same time. In the case of an extractor hood, for example, it is therefore possible to intensify a functional illumination which is directed onto a hob that is arranged beneath the extractor hood when a dish is being prepared on the hob. The indirect illumination does not necessarily also become brighter during this activity.

In the mounted position of the household appliance the top side of the functional component is located above the eye level of the user. As a result, the light intensity of the light source of the illumination entity can be chosen freely with no fear that the user will be dazzled. Since according to the invention the top side of the functional component is designed to allow the passage of light, and neither displays nor operating elements that must be visible for the user are usually provided on the top side of the functional component, this positioning of the household appliance can be carried out without compromising the operating convenience of the household appliance.

The light source of the illumination device is preferably directed upward. In the case of a functional illumination which is not provided separately from the illumination device, this orientation makes it possible to minimize the effect of the illumination entity on the lighting due to the illumination device. Consequently, the light-related requirements of the functional illumination can continue to be met. Moreover, the room ceiling is usually situated above the functional component, and therefore the light source of the illumination device is directed against this ceiling and hence the indirect room illumination is improved.

According to an embodiment, the light source of the illumination device can be configured such that it radiates colored light. This can be realized by means of light sources such as LEDs, for example, which output light in a specific wavelength. However, it is also possible to place color elements in front of a light source. This has the advantage that the color of the light that is radiated into the environment can be varied. An appropriate mood light can be generated in the environment of the household appliance by means of colored light.

The household appliance can have a memory unit for storing control scenarios of the illumination entity, said memory unit being connected to a control entity for controlling the illumination entity. Operating convenience is increased as a result of connecting the control means to a memory unit in which control scenarios can be stored. In comparison with the prior art, in which the control is limited to simply switching on or switching off and possibly dimming the illumination, in the case of this embodiment of the household appliance it is possible to preset defined illumination scenarios. Said illumination scenario can relate to the brightness of the illumination, the color tone, the duration of the illumination and possibly also to the use of only individual light sources of the illumination device. The scenarios can be stored in the memory unit at the factory. However, it is also possible to store user-defined illumination scenarios in the memory unit. The control unit can preferably also be actuated manually, i.e. the user can switch the illumination device on or off and make different adjustments without the need to provide the memory unit.

According to an embodiment, the household appliance has a time recording unit which is connected to the control unit. By virtue of this connection, an illumination type for a specific time of day or time of year can be set in the control unit itself or in the memory unit which is attached thereto. Thus, for example, an illumination having a warm color tone such as orange can be created in the winter, and in summer an illumination having a cool color tone such as blue. In addition to the choice of color tone depending on the time of year, it is also possible to adapt the illumination duration, for example. It could be shortened in the summer, for example. The time of day can be taken into consideration, i.e. by automatically starting the illumination at specific times.

According to an embodiment, the functional component is the suction screen of an extractor hood. The household appliance of an extractor hood is particularly suitable for the present invention, since this is usually installed at a height at which the top side of the suction screen and hence the top side of the functional component is not readily visible for the user and therefore optimal use can be made of the effect of the indirect illumination. Particularly in the case of what are called “island chimneys”, the suction screen can ideally be used for the illumination according to the invention. The filter for filtering cooking vapors that have been sucked in is provided in the suction screen. In addition, a functional illumination in the form of a workplace illumination is usually provided at the extractor screen. The light sources which are used for this purpose radiate light downward, in particular onto the cooking position which is situated beneath the extractor hood. By virtue of the top side of the suction screen being at least partially transparent, the light which is emitted by these light sources, in particular diffused light which is reflected upward, can already be used for the indirect illumination of the environment. Alternatively, however, separate light sources can be provided for the illumination according to the invention. These can be easily integrated in the case of an extractor screen, since this is only used for carrying the cooking vapors in the perimeter region and the inner space of the extractor screen in this region is therefore not required for other components.

According to the invention the functional component can, however, also be a cooker, and in particular an oven. In the case of an oven or a microwave likewise, a power supply is provided for the other functions and therefore the illumination according to the invention can be easily integrated. The illumination device can be provided between the oven chamber and the top side of the oven or the microwave. These household appliances can be fastened to a kitchen wall at the height of an eye-level cupboard, for example. As a result of this, the view into and access to the chamber space is simplified for the user. Again in the case of these appliances, the top side is thus not usually visible to the user and any dazzling effect can therefore be avoided. If the illumination device is embodied such that it can also generate colored light, e.g. a warm color tone can be also used in this context to represent the baking or heating process in the environment of the household appliance by means of the color effect.

Finally the functional component can also be a cooling device, in particular a refrigerator, comprising a refrigerated space. The household appliance, which can be a refrigerator or freezer in this context, can therefore also be used for indirect illumination.

The invention is explained again in detail below with reference to the accompanying figures, in which:

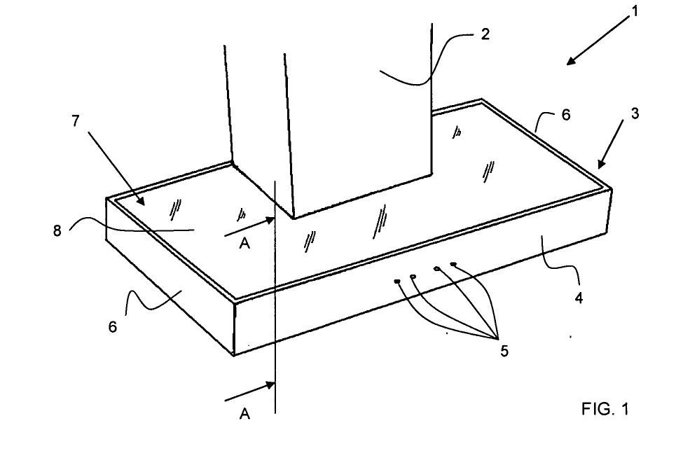

FIG. 1 shows a schematic perspective view of an embodiment of the household appliance according to the invention;

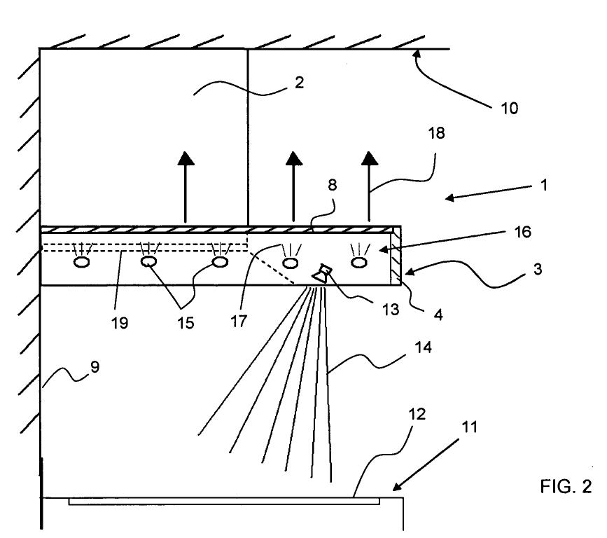

FIG. 2 shows a schematic sectional view through the embodiment of the household appliance in FIG. 1;

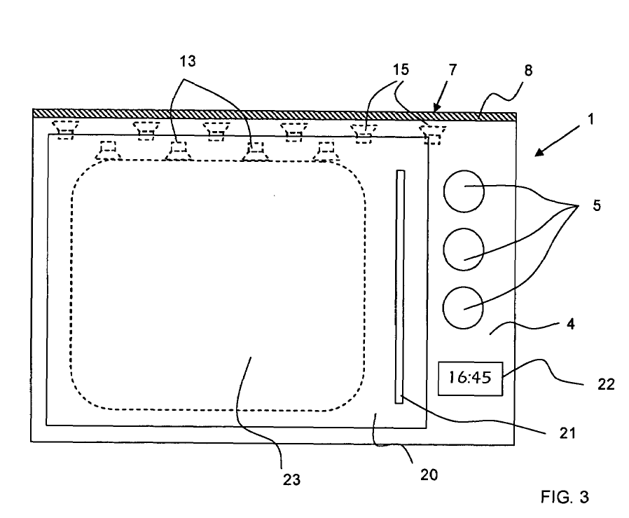

FIG. 3 shows a schematic frontal view of a further embodiment of the household appliance according to the invention; and

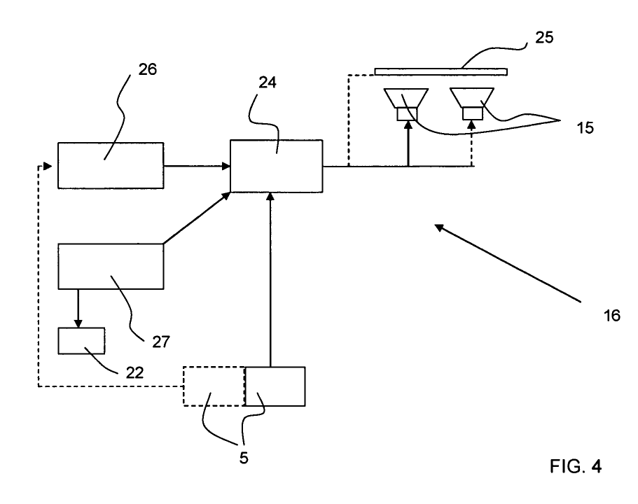

FIG. 4 shows a schematic block diagram of the components of an embodiment of the household appliance.

FIG. 1 shows a household appliance 1 according to the invention, in this case an extractor hood. In this exemplary embodiment, the extractor hood 1 is a wall chimney which consists of a flue 2 and a suction screen 3 which is arranged beneath the flue 2. The suction fan and the exhaust air pipe (not shown) of the extractor hood 1 can be provided in the flue 2. A filter (not shown) is accommodated in the extractor screen 3, which represents the functional component, in the region underneath the flue 2. Operating elements 5 by means of which individual functions of the extractor hood 1 can be controlled are provided at the front side 4 of the extractor screen 3. These operating elements 5 can be buttons. However, the operating elements can also be designed as receivers for signals from a remote control.

The extractor screen 3 is usually made of metal such as stainless steel, for example. In the case of the illustrated embodiment, the sides 6 and the front side 4 are manufactured from such a material. A panel 8 of translucent material is embedded in the top side 7 of the extractor screen 3. The panel 8 can be made of glass or plastic, e.g. polycarbonate, in particular Makrolon®. The panel 8 is embedded in the top side 7 of the extractor screen 3 in such a way that it forms a smooth surface with the top edge of the sides 6 and the front side 4. For this purpose, inwardly oriented support surfaces (not shown) can be provided at the sides 6 and the front side 4 of the extractor screen 3, wherein said support surfaces can be formed by a step in the material of the sides 6 and front side 4, or by angled regions at the sides 6 and the front side 4. As a result of the smooth surface of the top side 7, this can be easily cleaned.

In the section which is shown in FIG. 2 through the extractor screen 3 along the intersection line A-A from FIG. 1, the arrangement of components within the extractor screen 3 can be identified. The extractor hood 1 is fastened to a room wall 9 and the flue 2 extends above the extractor screen 3 as far as a room ceiling 10. A countertop 11 in which a hob 12 is embedded is arranged beneath the extractor screen 3.

A functional illuminator 13 providing a spotlight is arranged in the front region of the extractor screen 3. In the illustrated embodiment, this functional illuminator 13 serves to illuminate the countertop 11 or the hob 12. For this purpose, the functional illuminator 13 is directed downward onto the countertop 11 or the hob 12. A plurality of functional illuminators 13 can be provided across the width of the extractor screen 3 and also across its depth. The functional illuminator 13 which is visible in the front region of the extractor screen 3 in the sectional view of FIG. 3 is mounted in such a way that the light 14 which is radiated therefrom is directed diagonally rearward, i.e. in the direction of the room wall 9 behind the extractor hood 1. The user of the extractor hood 1 and the hob 12 is therefore not dazzled by the functional light 14. The functional illuminators 13 can be actuated by means of an operating element 5 at the front side 4 of the extractor screen 3.

Light sources 15 of the inventively provided illumination device 16 are also arranged in the extractor screen 3. The light sources 15 can be switched on and off e.g. by means of one of the operating elements 5 at the front side 4 of the extractor screen 3. These light sources 15 are directed upward. Consequently, the light sources 15 radiate illuminating light 17 toward the top side 7 of the extractor screen 3. By virtue of the material of the panel 8 which is embedded in the top side 7 of the extractor screen 3, the illuminating light 17 can pass through. This produces an illumination 18 which is directed at the room ceiling 10. As a result of reflection on the room ceiling 10, the illumination 18 acts as indirect illumination of the environment of the extractor screen 3 and hence of the extractor hood 1.

In the extractor screen 3 underneath the flue 2, provision is made for a filter 19 by means of which cooking vapors that are sucked up can be cleaned. The functional illuminator 13 is arranged in front of the filter 19, i.e. between the filter 19 and the front side 4 of the extractor screen 3. The light sources 15 of the illumination device 16 are likewise partially arranged in this region. Light sources 15 are also provided across the depth of the extractor screen 3 adjacent to the filter 19, i.e. between the filter 19 and the side 6 of the extractor screen 3. As a result of this, maximal use is made of the surface of the panel 8 for radiating illumination 18, and indirect illumination is also produced at the sides of the flue 2.

The light sources 15 of the illumination device 16 can be spotlights, LEDs or other common light sources.

FIG. 3 shows a further embodiment of a household appliance 1 according to the invention. In this embodiment, the household appliance 1 is a cooker, e.g. an oven or a microwave. A door 20 which can be opened by means of a handle 21 is arranged at the front side 4 of the cooker 1. Operating elements 5 by means of which e.g. the temperature in the cooker can be regulated are also provided at the front side 4. A time display 22 is represented beneath the operating elements 5 in the embodiment shown.

A cooking space 23 which is also called a chamber is arranged behind the door 20 in the interior of the cooker 1. Functional illuminators 13 which are used for lighting the chamber 23 are provided at the top side of the chamber 23. Said functional illuminators 13 can be switched on or off e.g. by means of one of the operating elements 5 at the front side 4 of the cooker 1. The functional illuminators 13 are directed downward. The top side 7 of the cooker 1 is formed by a panel 8 which consists of a translucent material. A plurality of light sources 15 which can likewise be controlled e.g. by means of an operating element 5 at the front side 4 of the cooker 1 are arranged between the chamber 23 and the panel 8. These are provided in a distributed manner across the entire surface of the cooker 1 and are therefore also arranged in the region of the operating elements 5. The light sources 15 are directed upward onto the panel 8. As a result of this, the light which is radiated by the light sources 15 can be radiated through the panel 8 into the region above the cooker 1. In the case of the cooker 1 also, therefore, an indirect illumination of the environment of the cooker 1 can be achieved by means of the light sources 15.

FIG. 4 shows a schematic block diagram of several components of the illumination device 16 that is used according to the invention. A control unit 24 for controlling the illumination is selected by means of an operating element 5 which can be attached at the front side 4 of the household appliance 1 as shown by way of example in FIG. 1 or FIG. 3. This control unit 24 is connected to the light source(s) 15 of the illumination device 16. An optionally provided color adjustment element 25 can also be controlled by means of the control unit 24.

A memory unit 26 and a time recording unit 27 are also illustrated. These units are also connected to the control unit 24. The light sources 15 that are to be controlled, the intensity of the light radiated by the individual light sources 15, the duration of the light radiation, the color of the radiated light, and further parameters can be defined in illumination scenarios stored in the memory unit 26. The illumination scenarios can be preset in the memory unit 26 at the factory and selected by the user by means of an operating element 5. However, it is also possible for the user manually to enter one or more illumination scenarios into the memory unit 26 via one of the operating elements 5. The control unit 24 will select the light sources 15 and/or the color adjustment element 25 in accordance with these scenarios.

The color adjustment element 25 can use e.g. a membrane disk which is equipped with different color areas, said disk being arranged in front of the light source 15 and converting the light that is radiated by the light source 15 into the desired color tone. However, the color adjustment element can also be a switch which, according to the desired light color, activates a light source 15 which is configured for outputting this color. It is therefore possible, for example, to provide a plurality of light sources 15, wherein some output a first color, e.g. blue, and others output a further color, e.g. orange. In the case of this embodiment, the color blue is achieved by means of the color adjustment element 25 by exclusively selecting the light sources 15 having blue light output.

The time recording unit 27 can be connected to the time display 22 of the household appliance 1 and supply the same with the current time of day and in certain cases the current date. The time recording unit 27 is also used for supplying the control unit 24 of the illumination device 16 with this information. If an illumination scenario which is stored in the memory unit 26 specifies e.g. that the illumination during the winter months should be set to orange, this adjustment of the illumination can take place on the basis of the time information provided by the time recording unit 27.

However, the light sources 15 of the illumination device 16 can also be activated or deactivated directly as a result of an operating element 5 being actuated by the user. In this case the control unit 24 can be omitted or serve merely to relay the actuation signal.

The components shown in FIG. 4 can be integrated with other units of the household appliance. For example, the control unit 24 can be integrated in a control device for controlling the functional illumination of the household appliance or another control unit of the household appliance.

On one hand, the present invention provides a household appliance which carries out the functional tasks of the household appliance, e.g. extracting cooking vapors, illuminating a countertop, cooking food and/or the lighting of the cooking space. On the other hand, the invention additionally provides a ceiling and/or room illumination. The light effect of said illumination can be increased by using colored light and light scenarios which can possibly be stored in the household appliance. In addition to the light effects that can be achieved, the advantage of the invention is that the user of the household appliance benefits from both the function of the household appliance and an associated functional illumination and a variable room lighting using the power supply which is available at the household appliance, e.g. via a power plug connector.

1-11. (canceled)

12. A household appliance, in particular a kitchen appliance, having at least one functional component including a top portion, the household appliance comprising at least one illumination device disposed in operative association with a first side of the top portion in the household appliance, the illumination device including a light source configured for at least partial light radiation directed to the top portion of the functional component, wherein the top portion of the functional component is formed at least partially from a translucent material for passing at least a portion of the light from the illumination device therethrough to a second side of the top portion of the functional component.

13. The appliance according to claim 12 and further comprising means for illuminating a function indicator of the functional component.

14. The household appliance according to one of claims 12 wherein the top side of the functional component is configured for installed disposition above a predetermined height at least one of generally corresponding to and exceeding an eye level of a user.

15. The household appliance according to one of claims 12 wherein the light source of the illumination device is directed generally vertically upwardly.

16. The household appliance according to one of claims 12 wherein the light source of the illumination device is configured to radiate light at a predetermined wavelength to produce and radiate colored light.

17. The household appliance according to one of claims 12 and further comprising a memory unit operatively associated with the household appliance for storing control programs for the illumination device, and a control unit operatively associated with the household appliance and in electronic communication with the memory unit for controlling the illumination device in accordance with the control programs.

18. The household appliance according to claim 17 and further comprising a time recording unit operatively connected to the control unit.

19. The household appliance according to claim 12 wherein the functional component is the suction screen of an extractor hood.

20. The household appliance according to claim 12 wherein the functional component is a cooker, in particular an oven.

21. The household appliance according to claim 12 wherein the functional component is a cooling device, in particular a refrigerator, including a refrigerated space.
